(19) United States
(12) Patent Application Publication
(10) Pub. No.: US 2008/0113649 A1
(43) Pub. Date: May 15, 2008

(54) Providing safety in relation to mobile stations

(76) Inventors: Eduardo Ibacache, Sundbyberg (SE); Kristian Gustafsson, Karlskrona (SE)

Correspondence Address: MYERS BIGEL SIBLEY & SAJOVEC, PO BOX 37428, RALEIGH, NC, 27627, US

(21) Appl. No.: 11/606,754

(22) Filed: Nov. 30, 2006

(30) Foreign Application Priority Data
Nov. 10, 2006 (SE) 0602409-5

(51) Int. Cl. H04M 3/16

(52) U.S. Cl. 455/410

(57) ABSTRACT

The security of a mobile station which is associated with a safety handling server is enhanced by routing, using a control unit in the mobile station, a data message according to a standardised transmission format sent from the safety handling server to a main safety handling application in the mobile station, and by applying, using the main safety handling application, a safety function on the mobile station according to security rules that are defined for the mobile station.

### FIELD OF THE INVENTION

The present invention relates to the field of providing security functionality for mobile communications and, more particularly, to methods of enhancing security in a mobile station that is associated with a safety handling server, and to related mobile stations, safety handling servers, and computer program products.

### BACKGROUND OF THE INVENTION

Mobile stations, such as wireless cellular communication telephones can have a number of applications and functions running in them, such as for making/receiving telephone calls, for sending and receiving messages, for browsing the Internet, taking photographs, etc.

Some mobile stations are owned by an employer (e.g., a company) and are provided for the convenience of use of its employees.

Some companies have extensive security measures provided regarding their buildings and computers. However this is often not the case with mobile stations. This means that such mobile stations may be used in many ways, which the rightful owner does not want it to be used in. There is therefore a need for companies to control their property. At the same time the mobile station is a tool that an employee should be allowed to use. However the use should be provided in a controlled way and according to the ways the company wants to. This is not such a simple task to achieve since mobile stations are in connection with a public wide area network, which the company in question does not have any control of.

There do exist some solutions for controlling devices in certain areas. In for instance US2003/0134627 there is described how a central control computer directly controls a mobile station from being used in a certain area. Here commands are sent to the mobile station. There does not seem to be included any client application in the device.

To improve security, it can be desirable to provide a mobile station with a client safety functionality which may make it easier to ensure that the mobile station is handled in a correct way and may perform security measures when there is no connection with a network. The device may then also on its own initiative inform a server that safety measures should be applied.

EP 1 035 746 describes a mobile station having a safety client application that performs different safety measures. Here the client application receives protection signals via a separate protection system.

However the owner of the property, i.e. the company that owns the mobile station, is often not content to only control the safety of the station in a limited area. It may very well be important to also control it outside of this area. This means that ordinary communication channels provided in a public wide area network have to be used for communicating with such a client application.

Since the actual user or employee having a mobile terminal is not always keen to have such control imposed by him/her, it is may be necessary that he/she is not directly informed that control is to be performed. Control signals sent in such data messages should therefore not be visible to the end user.

There does therefore exist a need for providing a safety handling client application in a mobile station, which can receive messages from a safety handling server virtually anywhere and where sending of these messages are hidden from the user, i.e. the messaging may be performed transparently.

### SUMMARY OF THE INVENTION

Embodiments of the present invention are directed towards providing a safety handling client application that can apply a variety of safety functions for a mobile station, where communication with a safety handling server can be hidden from the user of the mobile station.

Some embodiments of the present invention can provide a method of enhancing the security of a mobile station associated with safety handling server, where communication with the safety handling server is hidden for the user of the mobile station.

According to a first embodiment of the present invention, a method of enhancing the security of a mobile station associated with safety handling server includes the steps of:

receiving in the mobile station, at least one data message according to a standardised transmission format sent from the safety handling server,

routing, by a control unit in the mobile station, this message to a main safety handling application provided in the mobile station, and

applying, by the main safety handling application, a safety function on the mobile station according to security rules provided for the mobile station.

Some embodiments of the present invention can provide a mobile station having enhanced security in association with safety handling server, where communication with the safety handling server is hidden for the user of the mobile station.

According to a second embodiment of the present invention, a mobile station having enhanced security in association with a safety handling server, includes:

at least one communication unit, and

at least two application handling units including
at least one handling an application that a user of the device nominally has free access to, and
a main safety handling application unit handling a security application,

a control unit configured to
control reception and transmission of data via the communication unit, control the provision and reception of data to and from each application handling unit,
wherein the control unit is further configured to:
   receive at least one data message according to a standardised
   transmission format sent from the safety handling server, and
   route this message to the main safety handling application unit,
the main safety handling application unit is configured to apply a safety function on the mobile station according to security rules provided for the mobile station.

Some embodiments of the present invention can provide a computer program product for enhancing the security of a mobile station associated with safety handling server, where communication with the safety handling server is hidden for the user of the mobile station.

According to a third embodiment of the present invention, a computer program product for enhancing the security of a mobile station associated with a safety handling server includes:

computer program code, configured to make the mobile station, when the program code is loaded in the mobile station, provide a main safety handling application configured to, make a control unit of the mobile station to route data messages according to a standardised transmission format originating from the safety handling server to itself, and

apply a safety function on the mobile station according to security rules provided for the mobile station.

Some embodiments of present invention are directed towards further method and computer program product for enhancing the security of a mobile station from a safety handling server, as well as such a safety handling server, where: a data message according to a standardised transmission format sending and including at least one security related instruction is sent to the mobile station from the server, where the message includes an identifier indicating that the message is intended for a main safety handling application provided in the mobile station, which identifier enables the message to be routed to the main safety handling application unit internally in the mobile station, so that the main safety handling application can apply a safety function on the mobile station associated with the instruction.

Some embodiments of present invention are furthermore directed towards a method, mobile station and computer program product where a main safety handling application is started in the mobile station, which application is configured to apply a safety function on the mobile station according to security rules provided for the mobile station, a back-up safety handling application is started in the mobile station, the main safety handling application is monitored via the back-up safety handling application, and if the main safety handling application is terminated, the back-up safety handling application acts as a main safety handling application and starts a back-up safety handling application.

The present invention is furthermore directed towards a method, a mobile station and a computer program product where all data items of the mobile station apart from a limited set of frequently used items are encrypted, a main safety handling application in the mobile station applies a safety function on the mobile station according to security rules provided for the mobile station, where this applying of a safety function includes encrypting the remaining unencrypted data items.

Various embodiments of the present invention may provide one or more of the following advantages: enabling the provision of several different security functions that can be applied on a mobile station; providing transparent control of a client safety handling application provided in the mobile station; allowing the operation of the safety handling application to be transparent to the user, such that the user of the mobile station is not aware of it being there until the user does something the safety handling application does not allow, and/or enabling the safety application in the mobile station to properly operate at times when there is no contact with the server.

### BRIEF DESCRIPTION OF THE DRAWINGS

The present invention will now be described in more detail in relation to the enclosed drawings, in which:

FIG. 1 shows a mobile station communicating with a safety handling server via a wide area network, such as a cellular network, according to some embodiments of the present invention;

FIG. 2 shows a block schematic of the relevant parts of the mobile station according to some embodiments of the present invention;

FIG. 3 shows a block schematic of the relevant parts of the safety handling server according to some embodiments of the present invention;

FIG. 4 shows a flow chart of a number of method steps taken for ensuring the integrity of a safety handling client application provided in the mobile station according to some embodiments of the present invention; and

FIG. 5 shows a flow chart of a number of method steps performed in the safety handling server when sending an instruction to the mobile station according to some embodiments of the present invention;

FIG. 6, shows a flow chart of a number of method steps performed in the mobile station when receiving the instruction and acting on it according to some embodiments of the present invention; and

FIG. 7 shows a CD ROM disc on which program code for executing a method according to various embodiments of the present invention may reside.

### DETAILED DESCRIPTION OF EMBODIMENTS

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular exemplary embodiments illustrated in the accompanying drawings is not intended to be limiting of the invention. In the drawings, like numbers refer to like elements.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” and abbreviation “/” include any and all combinations of one or more of the associated listed items.

Embodiments of the present invention may take the form of a computer program product on a computer-readable storage medium having computer-readable program code embodied in the medium. Any suitable computer-readable storage medium may be utilized including a semiconductor or other electronic computer memory, a magnetic storage device such as a disk drive, and/or an optical storage device such as a CD drive and/or DVD drive.

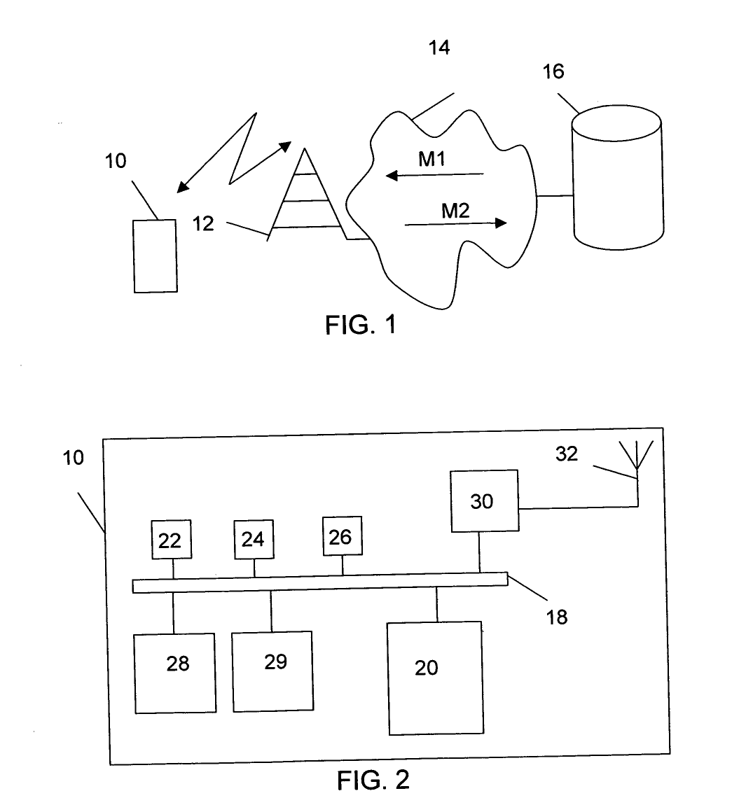

A mobile station 10 according to the present invention is in FIG. 1 shown communicating with a safety handling server 16 via a wide area network, and here in the form of a cellular network 14. For this reason the mobile station 10 is communicating with the network 14 via a base station 12

FIG. 2 shows a block schematic of a part of the interior of the mobile station 10 and configured in accordance with some embodiments of the present invention. The mobile station 10 includes a communication unit in the form of a radio communication unit 30 connected to an antenna 32 for communication with the network of FIG. 1. The radio communication unit 30 is also connected to a data bus 18. A control unit 20 is also connected to the data bus 18 and provides general control of different units in the mobile station 10. For this reason the control unit 20 is equipped with an operating system OS. To the bus 18 are furthermore connected a number of application handling units 22, 24, 26, 28 and 29, where a first 22 provides a camera application, i.e. provides software for controlling a camera in the mobile station 10, a second 24 provides a messaging function, i.e. it provides a function for sending and receiving messages for instance via the radio communication unit 30, a third provides a phone application, i.e. provides software for setting up and receiving phone calls via the radio communication unit 30. There is furthermore a fourth application handling unit 28. This fourth application handling unit 28 is a main safety handling application unit, i.e. it provides an application that is a safety handling client application arranged to be communication with the server of FIG. 1. In FIG. 2 there is finally provided a fifth application handling unit 29, which is a back-up safety handling application unit. This takes care of a back-up application to the main safety handling application. In the drawings the different application handling units are shown as separate hardware units in order to provide an easier understanding of the present invention. It should be understood that there may be more applications handled by these or additional application handling units. However, it should be understood that these units may with advantage be combined in one, two, three, hardware units etc. There may furthermore be provided several more units connected to the bus, such as a display, a keypad a camera, a speaker, microphone etc. However these are omitted for providing a clearer understanding of the present invention.

The applications handled by the application handling units 22-26 may be applications that a user nominally has free access to.

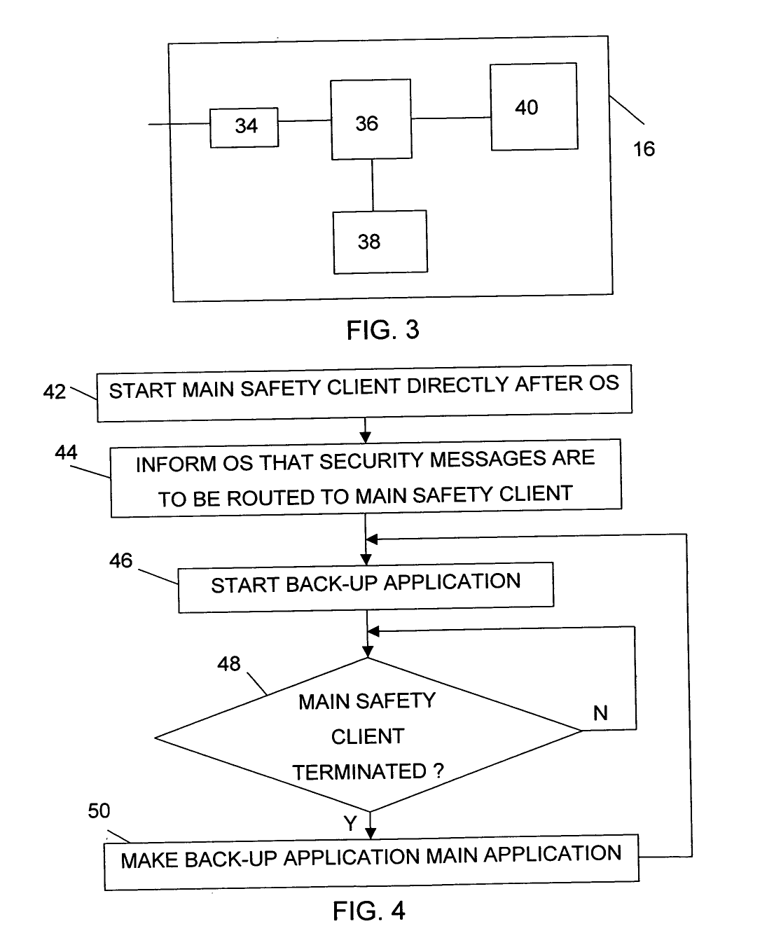

FIG. 3 shows a block schematic of a number of units of the safety handling server 16 according to some embodiments of the present invention. The server 16 comprises a communication unit 34 for communication with the network 14. The communication unit 34 may or may not be a radio communication unit depending on how the interface to the wide area network is implemented. Since the server 16 is stationary it is however not necessary that this part of the connection to the network is wireless. The communication unit 34 is connected to a control unit 36, which is in turn connected to a client store 38 and to an administration tool 40. The client store 38 includes information about mobile stations and rules regarding their uses, which rules may with advantage be input to the server via the administration tool 40. For this reason the administration tool 40 may be a Microsoft BizTalk server or a Microsoft Windows SharePoint server. It should however be understood that the administration tool need not be a separate entity.

The server 16 of FIG. 3 provides safety handling client applications that can be downloaded into mobile stations. It is here possible that a mobile station gets connected to a computer, for instance via a USB cable, from which computer the software may be downloaded. It may also communicate with the server via such a computer. It should be understood that there are several more ways in which a client handling application may be downloaded. It is also possible to do the downloading wirelessly via the network of FIG. 1 or some other network like a WLAN network. It may furthermore be downloaded from another server than the server in FIG. 3.

In relation to such a downloading, rules for a new safety handling client application to be provided in the mobile station may be defined by an administrator via the administration tool 40, which rules are then added, together with client information, to the client store 38 of the server 16. The administration tool may then convert the rules into a “Security Application Configuration Script Language” (SACSL) and pack them together with installation files that are required on the mobile station. The mobile station will then get connected to the server 16, either through a fixed connection or a wireless connection and the installation package is thereafter sent to and installed on the mobile station. After being installed the client application on the mobile station sends a “Device Information Packet” (DIP), with details about the mobile station, to the server which completes the registration process. This may be done through the client application sending a data packet including IMEI number, model, brand and IMSI number to the server.

After this has been done the safety handling client application may now be used. Various embodiments of the invention will now be described in the context of SMS (Short Message Service). It should however be understood that the invention is not limited to SMS, but may be applied for instance using TCP/IP messages or any other standardised transmission format.

A number of method steps performed in the mobile station in order to operate will mow be described with reference being made to FIG. 1, 2, 3 and 4, where the latter shows a number of method steps taken for ensuring the integrity of a safety handling client application provided in the mobile station.

When starting the mobile station 10 after the main client application has been loaded, the main client application in the main client application handling unit 28 is started directly after the Operating System provided by the control unit 20 is started, step 42. This prevents other user applications to interfere with the safety application. This may require hat no other software, which have files that will clash with the safety application, are installed before the safety application. Thereafter the main safety application 28 informs the control unit 20 to route safety messages coming from the safety handling server directly to the main client application, step 44. This is done through informing the control unit 20 that messages, here SMS messages, beginning with a known string, here also denoted identifier, should be routed to the main safety application 28. The control unit 20 then routes all these incoming messages starting with this identifier to the main safety handling client application 28. In this way the main safety handling client application 28 will be able to intercept the required data before the default SMS inbox of the messaging application 24 sees them, enabling fully transparent communication in the background. Thus the user of the mobile station 10 will not be able to see that messages are sent from the server to the client 28.

This may be accomplished through a so-called Socket-solution, where connections are established for sending and receiving messages, however only in one direction at a time.

In order to receive messages a socket may be bound to the SMS stack and an address provided on which it is desired to listen, such as shown by the pseudo-language example below:

// Connect to the socket service.
iSSrv.Connect( );
// Create a socket to the SMS message service through the socket server.
iSocket.Open(iSSrv, KSMSAddrFamily, KSockDatagram,
SMSDatagramProtocol);
// We're reading.
iBuf( ) = KSockSelectRead;
// Prepare our socket to receive SMS messages by matching a string.
TSmsAddr ISmsAddr;
ISmsAddr.SetSmsAddrFamily(ESmsAddrMatchText);
ISmsAddr.SetTeXtMatch(KSpDtpIdent( )); // String to match.
iSocket.Bind(ISmsAddr);
iSocket.Ioctl(KIOctlSelect, iStatus, &iBuf, KSOLSocket).

When run, the client application 28 will receive a signal via a so-called Active Object solution as soon as a message meeting the criteria is received by the mobile station 10.

As the main client application 28 is meant to provide security features to mobile stations and run transparent to the user, there are a few measures necessary to be taken in order for the application to run at all given times. Due to the nature of a mobile station, which runs on a small footprint, with regards to available resources, such as memory and limited speeds, the control unit 20 commonly starts an application only once and that application keeps running in the background when not being used. This is to minimise the times needed to launch the application at consecutive uses. This of course means there are a number of applications running in the background, which occupy memory, which the operating system of the control unit 20 might want to take back when required. When such a situation occurs, applications are given signals to shut down gracefully, i.e. store necessary data until loaded again next time. The operating system can also, if the application doesn't comply to the requests, ungracefully terminate the application. Also the user may try to terminate applications.

In order to avoid this situation for the safety application, the main safety handling application 28 starts a back-up application 29, step 46. Thus to prevent both the user and the control unit 20 from terminating the application, there is not only one application running, but two. The additional application, the back-up application 29, has the role of making sure that the client software isn't terminated. It therefore monitors the main safety handling application 28. If the main safety handling application 28 is terminated, step 48, the back-up application 29 steps in and now becomes the main application, step 50, and then goes on and starts a new back-up application, step 46. In this way it is guaranteed that there is always a safety handling client application up and running. In case the main application 28 was not terminated, step 48, the back-up application 29 goes back and watches if the main application 28 is terminated.

Apart from termination prevention, the back-up application 29 also provides the functionality of preventing files from being deleted. The safety applications own files are by default protected, but any file available in the file system can be protected from deletion, unless some other process has exclusive right to the file.

In order to make sure the given settings for the client application 28 aren't tampered with, the back-up application 29 also has the responsibility of managing the client's settings, storing them in an encrypted data file, which also is protected from deletion. These two latter functions could as an alternative also be provided by the main safety application 28. If the mobile station is turned off, naturally both the main and the back-up applications are terminated.

All communication between the main safety handling client 28 and server 16 can be done using a specially designed protocol which is intentionally kept extensible for future functionality. This protocol provides high-level functions, such as data acquisition, data manipulation, control, authentication and other security means, as well as application specific functions, such as requesting application-specific status information. The protocol has three major shapes:
Signature
A signature is a simple string sent from an answering party, unless it's over a link-less connection, in order to synchronise the state machines on each end.
Handshake
Handshaking is done in order to negotiate the lowest common protocol version between two entities at the start of a communication session, over a linked connection.
Request
There are two types of request packets, either a request or a response to a request. Responses are sent depending on the type of request.

### Data Transfer Protocol

In order to be able to send data over both linked and non-linked connections, the protocol data is, when necessary, split into packets of sizes suitable for the information transport means used. When for instance SMS is used this format allows data of sizes up to 140 octets to be transferred, whereas Ethernet has a default packet size of 1500 octets. The data packets are only used between two entities, where the sending entity splits the data into messages in the form of packets and the receiving entity reassembles the data from the received messages or packets.

The packets are uniquely identified, thus allowing the reassembly of packets that are received in a non-consequent order, which is necessary when using SMS as a means of data transfer.

Since the packet structure allows extendable size specifications, the amount of data that can be transferred over the connection is virtually unlimited.

All functions for the client are initiated and controlled by a script, which may be generated by the administration tool, which then is parsed and run by the client. The script language allows both generic functionality, such as arithmetic, as well as highly system specific functionalities.

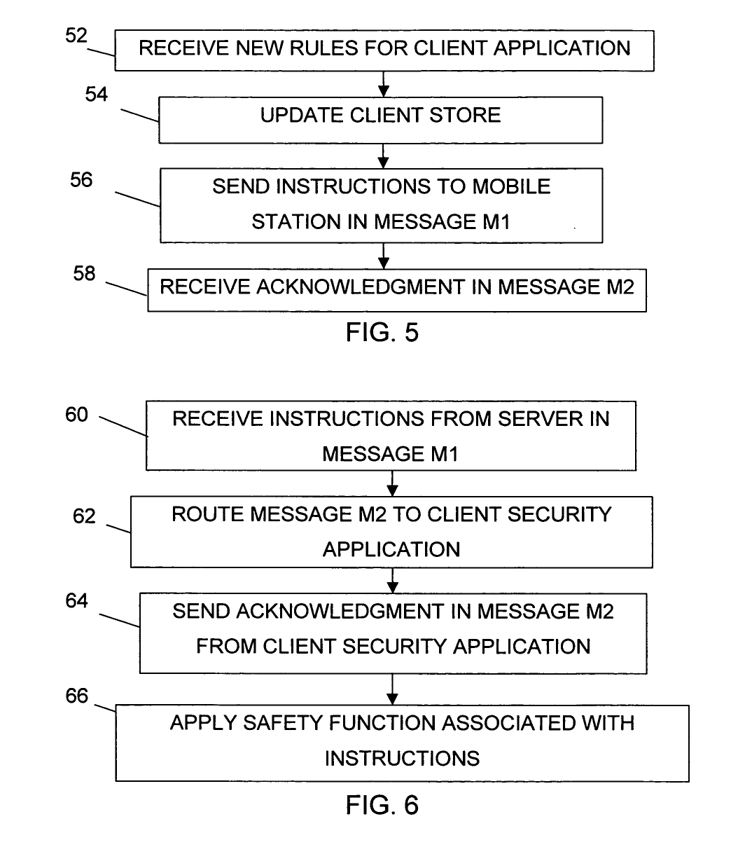

Now an exemplifying exchange of signals according to the present invention will be described in relation to FIG. 1-3 as well as to FIG. 5, which shows a flow chart of a number of method steps performed in the safety handling server when sending an instruction to the mobile station, and FIG. 6, which shows a flow chart of a number of method steps performed in the mobile station when receiving the instruction and acting on it.

As mentioned earlier security rules to be applied by the safety handling client are normally provided to the mobile station when the software is being installed. However, there may be a need for an upgrading. FIGS. 5 and 6 shows such a situation.

It all starts with an instruction in the form of new rules to be applied for the mobile station 10 are being provided. These rules may be received via the administration tool 40, step 52. The new instructions according to the correct format are then sent to the server control unit 36, which in turn updates the rules store, step 54. The server control unit 36 then prepares a packet of instructions to be sent to the mobile station 10 including these new rules. Therefore one or more messages M1 are prepared, which all include above named string in the beginning as well as the instruction. The messages M1 are then sent to the mobile station 10 via the communicating unit 34, step 56, and an acknowledgement is received in the server control unit 36 via the communication unit 34 via a message M2, step 58.

On the mobile station side, the message M1 is received by the radio communication unit 30, step 60. The control unit 20 then routes the messages M1 to the main security client application 28 based on the above mentioned string, step 62. In this way it is ensured that the message does not enter the SMS mailbox of the mobile station 10. As the messages M1 with the instruction are received by the main safety handling client application 28, receipt is acknowledged, step 64, whereupon the rules are updated. If now an event occurs that according to the rules should invoke a safety function, the corresponding safety function is applied, step 66. Thus it is possible for the main safety handling client application 28 to receive an instruction regarding a safety function in the form of a set of rules and when they should be applied, and then perform a monitoring of the conditions regarding the applying of a security function determined by the rules. The client application 28 may thus itself monitor if a condition is fulfilled, like if a certain event takes place, for applying a safety function, and if the event takes place the safety function is applied.

It should be understood that new rules may also be transferred via a normal wired connection. It should also be understood that the sending of an acknowledgement is optional.

A set of rules and an acknowledgement are just some examples of data that may be transferred in messages between the server and the client application. It is possible to send other data as well, such as requests for certain type of data. In this respect the server may request status information to be sent from the client safety handling application in order to ensure that the client safety handling application is running on the mobile station. It is also possible to configure the client to send out such status information at specific times, e.g. one time per day, one time every hour etc. In order to keep the system updated on how to be in contact with the client application, the client application sends an information packet whenever the SIM card of the mobile station is changed. This will update the system with the new SIM card identification (IMSI) number. If SMS is used, the message also includes the phone number of the mobile phone and then the server can connect the phone number to the SIM card and thus also the mobile station with currently and previously used SIM cards.

There are a number of different security functions supported by various embodiments of the present invention, where a few are mentioned below:
Call blocker
The safety handling client application can be made to prevent calls both to a list of phone numbers and calls from a list of phone numbers. The function works in such way that the client requests call status changes, which basically are signals denoting events to the call stack in the underlying operating system. When a useable status change occurs, such as call initiation or call ringing, the client application compares the phone number dialled or the phone number from the calling party, against the suitable phone number list. When there is a match, the call is simply terminated.
Message blocker
The safety handling client application can be made to block messages in the same way as it blocks calls.
Camera blocker
Very few mobile stations are today not equipped with camera devices. These are frequently in clash with company policies, which makes the purchase of mobile stations a fairly delicate business. The safety handling client application provides the functionality of blocking the use of the camera in supported devices.
The camera blocker works in such way that the client application requests to be notified when the user or an application want to take ownership over the camera, which is the case when it is going to be used. By intercepting this signal, the client application is given the possibility to take ownership of the camera before the requesting application can, thus effectively rendering the camera unusable.
Data eraser/Data encryption
The client application has the ability to erase arbitrary data upon request. The data is erased by first restarting the device, in order to obtain full accessibility to the data. The data is then removed from the device, using both built-in features for data manipulation, as well as ordinary file system calls. Data contemplated for such erasing are phone book entries, messages received to and sent from the mobile station, stored either in the built-in memory or on any non-protected memory cards.

There are a number of different types of conditions that can be monitored in order invoke one of the blocking functions above, where some examples are given below,
Position
It is possible to use the position of the mobile station as a condition for invoking a safety function. This may be based on Cell-ID. Cell-ID is the identification of the base station to which a mobile station using the network is communicating with. A cell-ID contains information about which country the base station is located in, which network operator is in effect, which region of the network operator that has assigned the base station and the cell identification itself. All these parts can be used together or by themselves in order to select whether a function shall be applied or not.
In case the mobile station is provided with a separate positioning application, like GPS, the position according to this positioning application may also be used for applying a safety function.
Time
The client application can execute functions depending on timing parameters, such as within a certain time interval between two dates as well as at a given time and date. In order to protect against the user changing the time on the mobile station, the client application may internally use the time used by the rest of the safety system together with an offset to the mobile station local time. Any change to the local time is noticed and the offset is changed accordingly.
Status
Also the status of the mobile station may be used for invoking a safety function, for instance the status associated with a low battery power level
Profile
Finally it is also possible to use a profile of the mobile station in order to invoke a safety function. This may typically be that phone calls and/or messages should not be allowed to a certain type of phone numbers or recipients.

As has been mentioned above the safety handling client application may detect if a new SIM-card has been inserted in the mobile station and inform the server of this fact. It is furthermore possible to block the phone, erase or encrypt data based on a new SIM card. In this case the server may send out new rules set to block the station, erase data or encrypt data. It may also directly send a command relating to this fact. The mobile station may also report a new SIM card to the server, which may then decide to block the mobile station. Also in this case the server may send out a command to the mobile station, which immediately blocks the station, erases data or encrypts data.

When blocking a mobile station it is possible to block the station before it enters the PIN code entering sequence mode, which thus totally blocks the device. When encrypting data, it is furthermore possible to only encrypt some data. According to this variation of the present invention, all data except for a limited set of frequently used data items, such as contact information, recently received messages and possibly some other frequently used data. The rest is encrypted and may be decrypted via the safety handling client application if needed. When an instruction to encrypt the mobile station is received or when a rule provided in the safety handling client application indicates this, then only this data is encrypted, since the rest of the data items are already encrypted. This allows a very fast encryption of the mobile station

It is furthermore possible that the actual determination of if a security function is to be invoked is determined by the server. In this case the safety handling client application may send data enabling the server to determine a security risk situation, which data may be data signalling one or more of the above mentioned events or conditions. Thereafter the server investigates the rules and determines if one or more of the functions are to be applied. Thereafter it sends a command or instruction to the mobile station as a response to the data and the safety client function thereafter applies the safety measure associated with the command.

The server has the functionality to manage all data in the system, like mobile phones, users, SIM-cards, cell areas and logs. This data is stored in the client store and is accessible to external applications.

Some embodiments of the present invention enable the provision of several different security functions. According to some embodiments of the present invention, transparent control of a client safety handling application provided in a mobile station is achieved. The user of the mobile station is thus not aware of it being there and operating until he does something the safety handling application does not allow. By using a back-up safety application, it is furthermore ensured that the application cannot be terminated and will always be up and running when the mobile station is turned on. Through providing a client solution in this way it is furthermore possible to limit the amount of data sent between the mobile station and the server, since rules for the safety handling application may be provided when installing this application. The safety application provided in the mobile station may furthermore work at times when there is no contact with the server. By having most of the data encrypted, a total encryption of the mobile station can be very fast, since only a small number of remaining data items need to be encrypted.

The control unit and application handling units in the mobile station are according to some embodiments of the present invention preferably provided in the form of one or more processors with corresponding memory containing the program code for performing the functions of these units. The communication unit is provided as a separate hardware module, for instance in the form of an ASIC circuit.

In the server, the control unit and administration tool may also be provided in the same way as in the above described units of the mobile station. The communication unit is preferably provided in the form of a standardised network interface and the client store is also an ordinary memory module such as a RAM, ROM or a flash memory.

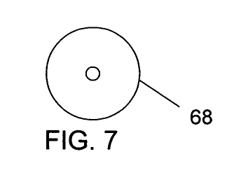

The program code mentioned above can also be provided on one or more computer program products such as a CD ROM disc 68 as depicted in FIG. 7, which will perform various embodiments of the present invention when loaded into a mobile station having suitable processing capabilities. Naturally other types of products can be provided as such a carrier, like for instance a removable memory like a memory stick. The computer program product can also be provided as software, which is downloaded remotely from a server either outside or inside the wide area network or which is downloaded via a computer like a PC to which the mobile station is temporarily connected. The software for the server may be provided in the same or similar ways.

Although the present invention has been described in connection with specific embodiments, it is not intended to be limited to the specific form set forth herein. Rather, the scope of the present invention is set forth by the accompanying claims.

What is claimed is:

1. A method of enhancing the security of a mobile station associated with a safety handling server, the method comprising:
receiving in the mobile station, at least one data message according to a standardised transmission format sent from the safety handling server;
routing, by a control unit in the mobile station, the received message to a main safety handling application provided in the mobile station, and
applying, by the main safety handling application, a safety function on the mobile station according to security rules provided for the mobile station.

2. The method according to claim 1, wherein the safety function is applied based on position data related to the mobile station, time data, status data of the mobile station and/or profile data related to the mobile station.

3. The method according to claim 1, wherein the message includes an identifier indicating that the message is intended for the main safety handling application, and the received message is routed by the control unit to the main safety handling application in response to the identifier.

4. The method according to claim 1, further comprising starting the main safety handling application after the mobile station is turned on and as soon as the control unit has started to operate.

5. The method according to claim 4, further comprising informing, by the main safety handling application, the control unit that data messages from the safety handling server are to be routed to the main safety handling application when being started.

6. The method according to claim 1, further comprising:
starting a back-up safety handling application in the mobile station; and
monitoring the main safety handling application via the back-up safety handling application, and, if the main safety handling application is terminated from performing, then replacing functionality of the main safety handling application with functionality of the back-up safety handling application.

7. The method according to claim 1, wherein the safety function causes the mobile station to carry out at least one operation in the group of: blocking a camera in the mobile station, blocking calls to the mobile station, blocking messaging to the mobile station, erasing data in the mobile station, and/or encrypting data in the mobile station.

8. The method according to claim 7, wherein:
all data items of the mobile station apart from a limited set of frequently used items are encrypted; and
applying the safety function comprises encrypting, by the main safety handling application, the frequently used data items that remain unencrypted.

9. A mobile station having enhanced security and which is associated with a safety handling server, the mobile station comprising:
at least one communication unit;
at least two application handling units, each including
at least one handling an application that a user of the device nominally has free access to, and
a main safety handling application unit handling a security application; and
a control unit configured to control reception and transmission of data via the communication unit, control the provision and reception of data to and from each application handling unit, receive at least one data message according to a standardised transmission format sent from the safety handling server, and route the received message to the main safety handling application unit, wherein the main safety handling application unit is configured to apply a safety function on the mobile station according to security rules provided for the mobile station.

10. The mobile station according to claim 9, wherein the message includes an identifier indicating that the message is intended for the main safety handling application unit, and the received message is routed by the control unit to the main safety handling application in response to the identifier.

11. The mobile station according to claim 9, wherein the main safety handling application unit is configured to start up the main safety handling application when the mobile station is turned on and immediately after the control unit has started to operate.

12. The mobile station according to claim 11, wherein the main safety handling application when being started is further configured to inform the control unit that data messages from the safety handling server are to be routed to it.

13. The mobile station according to claim 9, further comprising a back-up safety handling application unit providing a back-up safety handling application configured to monitor the main safety handling application, and to act as a new main safety handling application and start another back-up safety handling application when operation of the main safety handling application becomes terminated.

14. The mobile station according to claim 13, wherein all data items of the mobile station apart from a limited set of frequently used data items are encrypted, wherein the main safety handling application when applying a safety handling function is further configured to encrypt the frequently used data items that remain unencrypted.

15. A computer program product for enhancing the security of a mobile station associated with a safety handling server, the computer program product including a computer usable storage medium having computer readable program code embodied in the medium, the computer usable storage medium comprising:
computer readable program code that is configured to make the mobile station, when the program code is loaded in the mobile station, provide a main safety handling application that causes a control unit of the mobile station to route data messages according to a standardised transmission format originating from the safety handling server to itself, and that carries out a safety function on the mobile station according to security rules provided for the mobile station.

16. A method of enhancing the security of a mobile station from a safety handling server, the method comprising:
sending a data message according to a standardised transmission format and including at least one security related instruction to the mobile station, wherein the message includes an identifier indicating that the message is intended for a main safety handling application provided in the mobile station;
routing the message to the main safety handling application within the mobile station in response to the identifier; and
operating the main safety handling application to carry out a safety function on the mobile station in response to the security related instruction.

17. The method according to claim 16, wherein the security related instruction provides a safety function that is applied based on position data related to the mobile station, time data, status data of the mobile station, and/or profile data related to the mobile station.

18. The method according to claim 17, wherein the security related instruction causes the mobile station to carry out at least one operation among the group of: blocking a camera in the mobile station, blocking calls to the mobile station, blocking messaging to the mobile station, erasing data in the mobile station, and/or encrypting data in the mobile station.

19. A safety handling server for enhancing the security of a mobile station, the safety handling server comprising:
a client store comprising information about mobile stations and rules associated with users of the mobile stations; and
a control unit configured to send a data message according to a standardised transmission format including at least one security related instruction to the mobile station,
wherein the message includes an identifier indicating that the message is intended for a main safety handling application provided in the mobile station, and the identifier is configured to cause the mobile station to route the message to the main safety handling application within the mobile station and to cause the main safety handling application to carry out a safety function on the mobile station in response to the security related instruction.

20. A computer program product for enhancing the security of a mobile station, the computer program product including a computer usable storage medium having computer readable program code embodied in the medium, the computer usable storage medium comprising:
computer program code configured to cause a safety handling server in which it is hosted to send a data message according to a standardised transmission format and including at least one security related instruction to the mobile station,
wherein the message includes an identifier indicating that the message is intended for a main safety handling application provided in the mobile station, and is configured to cause the message to be routed to the main safety handling application within the mobile station, and to cause the main safety handling application to carry out a safety function on the mobile station in response to the security related instruction.

21. A method of enhancing the security of a mobile station and comprising:
starting a main safety handling application in the mobile station, the main safety handling application is configured to apply a safety function on the mobile station according to security rules defined for the mobile station;
starting a back-up safety handling application in the mobile station;
monitoring the main safety handling application via the back-up safety handling application; and
responding to termination of operation of main safety handling application by causing the back-up safety handling application to carry out the functionality of the main safety handling application, and by starting another back-up safety handling application.

22. A mobile station having enhanced security, the mobile station comprising:
a main safety handling application unit with a main security application; a back-up safety handling application unit with a back-up security application that is started by the main safety handling application and which is configured to monitor the main safety handling application and to take-over providing functionality of the main safety handling application and to start another back-up safety handling application when operation of the main safety handling application becomes terminated.

23. A computer program product for enhancing the security of a mobile station, the computer program product including a computer usable storage medium having computer readable program code embodied in the medium, the computer usable storage medium comprising:
computer program code configured to cause the mobile station, when the program code is loaded in the mobile station, to provide a main safety handling application that applies a safety function on the mobile station according to security rules defined for the mobile station, and to start a back-up safety handling application in the mobile station, wherein the back-up handling application is configured to monitor the main safety handling application, and, when operation of the main safety handling application becomes terminated, to take-over providing functionality of the main safety handling application and to start a back-up safety handling application.

24. A method of enhancing the security of a mobile station, the method comprising:
applying, using a main safety handling application in the mobile station, a safety function on the mobile station according to security rules defined for the mobile station to encrypt frequently used data items in the mobile station which had not previously been encrypted.

25. A mobile station having enhanced security, the mobile station comprising:
a safety handling application unit with a security application configured to apply a safety function on the mobile station according to security rules defined for the mobile station, wherein all data items of the mobile station, apart from a limited set of frequently used items, are encrypted, and wherein the safety handling application unit applies the safety function by encrypting the remaining unencrypted data items.

26. A computer program product for enhancing the security of a mobile station, the computer program product including a computer usable storage medium having computer readable program code embodied in the medium, the computer usable storage medium comprising:
computer program code configured to be loaded in the mobile station and cause the mobile station to provide a safety application that carries out a safety function on the mobile station according to security rules defined for the mobile station to encrypt frequently used data items in the mobile station which had not previously been encrypted.
